(19) United States
(12) Patent Application Publication
(10) Pub. No.: US 2007/0278319 A1
(43) Pub. Date: Dec. 6, 2007

(54) Gas oven with proportional gas supply

(76) Inventors: Anthony E. Jenkins, Stevensville, MI (US); Andrea M. Corda, Luino (IT); Daniele Franchi, Bodio Lomnago (VA) (IT); John W. Lockwood, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/434,307

(22) Filed: May 15, 2006

(51) Int. Cl. F24C 15/32; G05D 23/02

(52) U.S. Cl. 236/15 A; 126/273 R

(57) ABSTRACT

A gas oven, is provided with a proportionally adjustable gas to regulate the temperature of the oven.

### BACKGROUND OF THE INVENTION

1. Field of the Invention

This invention relates generally to a gas valve for a consumer appliance, and more specifically to a proportional gas valve allowing the gas flow rate to be proportionally adjusted by a control system.

2. Description of the Related Art

Gas-supplied household appliances, such as gas ranges or ovens, typically employ one or more valves to regulate the flow of gas to the appliance. The gas is specifically delivered to a heating element, such as a gas burner. In the case of a gas oven, the appliance also has a control system that regulates the temperature of the oven cavity in accordance with a temperature set point programmed by a user. The control system acts to maintain the oven cavity at the temperature set point by opening and closing the valve to raise and lower, respectively, the oven cavity temperature. Traditionally, only ON/OFF valves are used in ovens. ON/OFF valves function just as their name implies. When the valve is open, it is completely open and gas flows through at a maximum rate. When the valve is closed, no gas flows through. These valves are normally solenoid valves that have only the two ON and OFF positions.

Controllers for the ON/OFF valves open and close the valve to maintain the oven temperature at a user-selected set point. Most controllers are programmed to avoid rapid cycling of the burner because each cycle requires ignition and the ignitions are typically audible, which can be an annoyance for some users. Also, the repeated cycling of the valve reduces the life of the valve and ignition components.

The desire to reduce the number of ignitions is made more difficult in that the heat output of the gas burner is normally selected such that it can quickly reach and easily maintain the highest anticipated cooking temperature, which is usually around 350° F. For self-cleaning ovens, the heat output is selected to reach the very high temperatures, around 830° F., necessary for pyrolytic cleaning.

As the burner output is selected to meet the highest anticipated temperature and the burner can only be ON or OFF, the oven temperature often quickly rises above the user-selected set point for the traditional cooking temperatures of around 350° F. To avoid rapid ON/OFF cycling of the burner, the controller normally cycles the valve between upper and lower trip points relative to the user-selected set point. The upper trip point is greater than the set point and the lower trip point is less than the set point. This cycling of valve between the trip points results in the oven temperature that is rarely at the temperature set point, and instead oscillates above and below the temperature set point. This is illustrated in FIG. 1, where a schematic temperature profile for a prior art gas oven is given. As can be seen, for a temperature set point of 350° F., after initially heating the oven cavity, the oven cavity temperature continuously oscillates above and below the temperature set point according to the trip points.

The trip points are selected as a compromise between minimizing the cycling of the burner and maintaining an average temperature close to the set point. The trip points must also take into account that the response of gas burner is not instantaneous for a variety of reasons. Thus, the burner will introduce some heat after the upper trip point is reaches and the burner will not immediately begin heating when the lower trip point is reached. The result is that the oven cavity will often cycle between a temperature slightly above the upper trip point and slightly be the lower trip point.

Therefore, current oven and their temperature control systems are a compromise between temperature accuracy and life cycle of the temperature control system.

### SUMMARY OF THE INVENTION

The invention addresses the compromise of current temperature control systems by providing a gas oven comprising a housing defining a cooking chamber, a temperature sensor outputting a temperature signal indicative of the air temperature of the cooking chamber, a gas heating element heating the air in the cooking chamber, a proportional valve regulating the supply of gas to the heating element in response to a control signal, and a controller operably coupled to the temperature sensor to receive the temperature signal and operably coupled to the proportional valve, where the controller generates the control signal in response to the temperature signal to maintain the air temperature of the cooking chamber at a temperature set point.

The gas oven can further comprise a user interface operably connected to the controller that is configured to permit a user to input a user-selected set temperature as the set point. The controller can repeatedly receive the temperature signal and generate the corresponding control signal. The proportional valve can comprise a motor to selectively open the valve in response to the control signal. The motor can be infinitely adjustable to move the proportional valve to one of an infinite number of positions between closed and completely open. The motor can be discretely adjustable to move the proportional valve to one of a discrete number of positions between closed and completely open. The motor can be a stepper motor.

According to another aspect of the invention, a method is provided for maintaining the cooking temperature of a gas oven having a cooking chamber heated by a gas heating element at a user-selected set temperature. The method comprises sensing the air temperature of the cooking chamber, and proportionally controlling the supply of gas to the gas heating element in response to the sensed air temperature to maintain the air temperature of the cooking chamber at the set temperature.

The method can further comprise repeatedly sensing the air temperature of the cooking chamber and proportionally controlling the supply of gas in response to the repeatedly sensed air temperatures. The repeated sensing of the air temperature and corresponding proportional controlling can be conducted throughout an operational cycle. The supply of gas can be proportionally controlled by moving a proportional valve. The proportional control of the supply of gas can be infinitely adjustable. The proportional control of the supply of gas can be discretely adjustable. The discretely adjustable supply of gas can be discretely adjustable in predetermined increments. The predetermined increments can be equal or non-equal.

### BRIEF DESCRIPTION OF THE DRAWINGS

In the drawings:

FIG. 1 is a graphical representation of a temperature profile of a prior art gas oven.

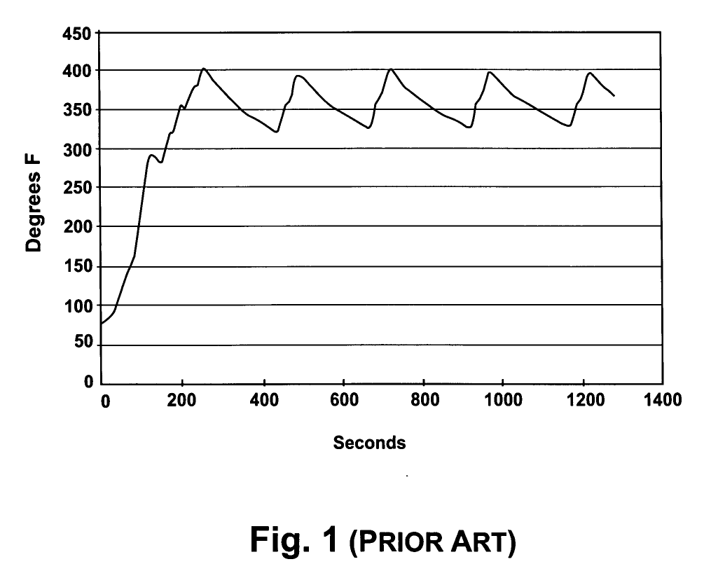

FIG. 2 is a schematic illustration of a gas oven according to the present invention.

FIG. 3 is a schematic illustration of a proportional valve according to the present invention.

FIG. 4 is a block diagram of a method for maintaining the cooking temperature of the gas oven according to the present invention.

FIG. 5 is a graphical representation of a temperature profile of the gas oven according to the present invention.

### DESCRIPTION OF THE PREFERRED EMBODIMENT

A gas-supplied household appliance, such as a gas oven, according to the invention is provided with a proportional valve for regulating the supply of gas to the oven and a control system for controlling the proportional valve to regulate the temperature of a cooking chamber to alleviate problems caused by the use of ON/OFF valves. Because the use of a proportional valve allows the gas flow rate to be adjusted from 0-100% of the maximum flow rate, the temperature of the cooking chamber can be maintained closer to a set temperature for improved cooking performance.

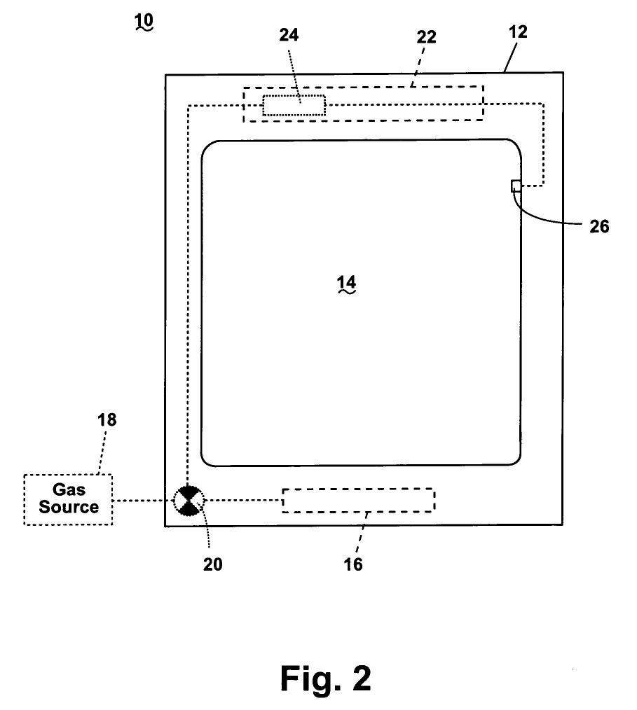

Referring now to the drawings, and in particular to FIG. 2, a gas oven 10 according to the invention is schematically illustrated. Generally, the gas oven comprises a housing 12 that defines a cooking chamber 14 within, such as is commonly closed by an oven door (not shown). The cooking chamber 14 is heated by a heating element 16, comprising one or more conventional gas burner(s), connected to a source of gas 18. A proportional valve 20 is interposed between the heating element 16 and gas source 18 to regulate the supply of gas to the heating element 16. The proportional valve 20 is movable through a range of positions, from a closed position where gas does not flow through the valve, to a fully open position where gas flow through the valve at a maximum rate. The proportional valve 20 can further be adjusted to other open positions to allow gas to flow through the valve at flow rates other than the maximum rate.

A user interface 22 is provided on the exterior of the housing 12 in a location that is convenient for a user to access. The user interface 22 is configured to allow the user to input a temperature set point, where the temperature set point is the temperature that the user desires the cooking chamber 14 to reach for a cooking operation. A suitable user interface is disclosed in U.S. Pat. No. 6,786,058 to Sanna, whose disclosure is incorporated by reference. However, any of the well known user interfaces can be used, including: mechanical knobs and dials, and electronic user interfaces, such as touch buttons or capacitance touch panels.

A controller 24 is operably coupled to the proportional valve 20 for controlling to opening and closing of the valve, thus controlling the gas flow rate through the valve. The controller 24 employs a control system algorithm to provide proper valve positioning. Any of the currently used controllers may be used, which include, but are not limited to, proportional, PI, PID, and fuzzy logic controllers. A suitable controller is disclosed in U.S. Pat. No. 6,163,017 to Corda et al., whose disclosure is incorporated by reference.

The controller 24 receives information from one or more temperature sensor(s) 26 positioned within the oven 10 to detect the air temperature in the cooking chamber 14. The temperature sensor 26 provides an indication of the cooking chamber temperature to the controller 24 in the form of a temperature signal that can be received by the controller 24. The controller 24 uses the temperature signal to determine the appropriate valve position and generates a control signal corresponding to the determined appropriate valve position. The control signal prompts the proportional valve 20 to move to the position defined by the control signal. The controller 24 repeatedly received information from the temperature sensor 26 and adjusts the position of the proportional valve 20 as needed through an operational cycle of the gas oven. The operational cycle can be any predetermined or user-inputted heating program that the oven performs, such as, but not limited to cooking cycles, self-cleaning cycles, warming cycles, and bread-proofing cycles.

The proportional valve 20 may be an infinitely adjustable proportional valve that can be set at any desired flow rate between 0% and 100%. The proportional valve 20 may also be discretely adjustable in sufficiently small amounts. For example, the proportional valve 20 may be adjustable in 1% increments. The degree of adjustability of the proportional valve 20 need only be fine enough to maintain the oven temperature at the desired set point within the desired range of accuracy, which can be limited by the controller 24 and the user interface 22. For example, the user interface 22 may only permit temperature adjustments in steps of 5° F. Under such circumstances, the resolution of the adjustability of the proportional valve 20 need only be fine enough to resolve the 5° F. temperature adjustments.

The proportional valve 20 may also be discretely adjustable in non-equal increments. For example, cooking cycles may be commonly preformed within a known range of cooking temperatures, such as between 170 and 550° F., while self-cleaning cycles may be commonly preformed within a higher known range of self-cleaning temperatures, such as between 800 and 850° F. As such, there is no need to regulate the temperature of the cooking chamber 14 between the range of cooking temperatures and the range of self-cleaning temperatures, in this example, between 550 and 800° F. Within the 550 to 800° F. temperature range, the proportional valve 20 may, for example, be adjustable in relatively large increments as compared to the incremental adjustments made in the cooking and self-cleaning temperature ranges. Additionally, the relationship between energy input to the oven 10 and resulting air temperature in the cooking chamber 14 is a non-linear function due to factors such as burner efficiencies (at different flow rates), the temperature gradient between air in the oven 10 and ambient air exterior of the oven 10, the design of the oven air intake system and design of oven venting system. Thus, it may be desirable for the proportional valve 20 to also provide a non-linear position vs. flow rate response curve to provide better performance.

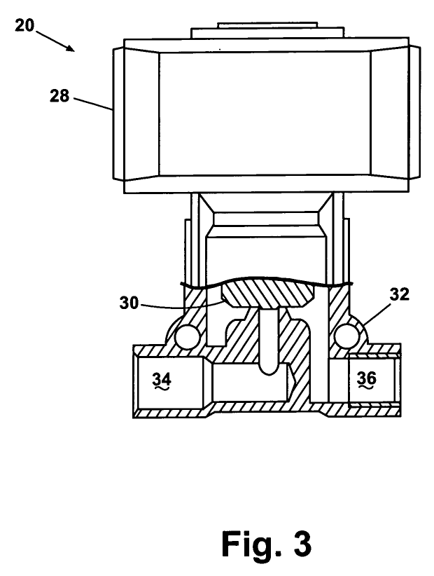

FIG. 3 discloses one suitable proportional valve 20, comprising a valve body 32, a motor 28 that is driven by the controller 24 and a movable valve element 30 that is controls the rate of gas flow through the proportional valve 20. The motor 28 and valve element 30 are mechanically linked (not shown). The mechanical linkage between the motor 28 and the valve element 30 causes the valve position to change dependently on the motor position. The motor 28 can be infinitely or discretely adjustable to position the valve element 30 accordingly within the desired range of accuracy. A suitable discretely-adjustable motor 28 is a stepper motor, which are particularly useful for applications requiring frequent starting and stopping of the motor. Stepper motors also have the characteristic of holding torque, which allows the stepper motor to firmly maintain its position when not turning.

The valve 20 is illustrated in a closed position, where no gas flows through the valve. In an open position, the valve element 30 is raised, thus permitting gas to flow from inlet 34, which is fluidly connected to the gas source 18, and through outlet 36, which is fluidly connected to the heating element 16. The extent to which the valve element 30 is raised corresponds to the rate of gas flow through the proportional valve 20.

It will be understood that the particular proportional valve is not germane to the invention. Furthermore, the valve position may be controlled by a variety of devices other than a motor 28, including, but not limited to, a solenoid actuator, an analog control that provides an analog voltage output to a motor winding, which acts to the change the valve position in an manner directly or inversely proportional to the voltage, and a binary linear coil actuator.

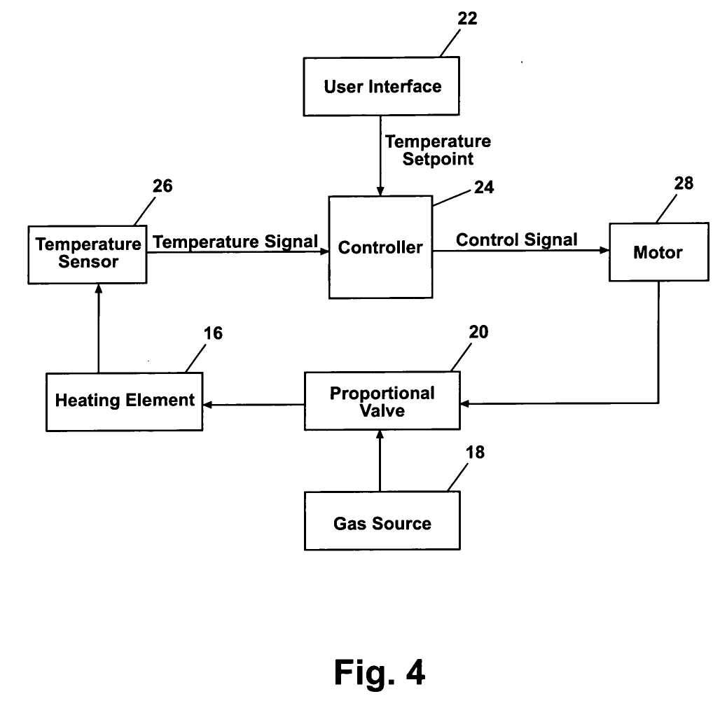

Referring to FIG. 4, a block diagram of a control system according to the invention is illustrated. The control system is a closed-loop system, where feedback from the temperature sensor 26 is used to determine an appropriate valve position based on the user-selected temperature set point. Initially, the user inputs a temperature set point into the user interface 22. The controller 24 determines an appropriate valve position based on the user-selected temperature set point and generates a corresponding control signal which is received by the stepper motor 28. The stepper motor 28 will move to the position defined by the control signal, which also causes the proportional valve 20 to move to a corresponding valve position. Gas flows through the proportional valve 20 to the heating element 16 to heat the cooking chamber 14. The rate of gas flow is 0 to 100% of the maximum flow rate and is determined by the valve position. The temperature of the cooking chamber 14 is sensed by the temperature sensor 26, which generates a temperature signal that is received by the controller 24. Based on the temperature signal and the user-selected temperature set point, the controller 24 determines an appropriate valve position. If proportional valve 20 is not at the appropriate valve position, the controller 24 provides a new control signal to the stepper motor 28 to move the proportional valve 20 to the appropriate valve position. If the proportional valve 20 is at the appropriate valve position, the controller 24 provides the same new control signal. Alternately, the controller 24 may not generate a control signal if the proportional valve is at the appropriate valve position. The control system cycles through these steps repeatedly throughout the operational cycle.

It should be noted that the controller 24 can be programmed to take account of circumstances in the operational cycle. For example, at start-up, the controller 24 may maintain the proportional valve 20 100% open until the set point is reached as this will provide the fastest warm up of the oven. Once the set point is reached, the controller 24 will control the proportional valve 20 to maintain the temperature at the set point.

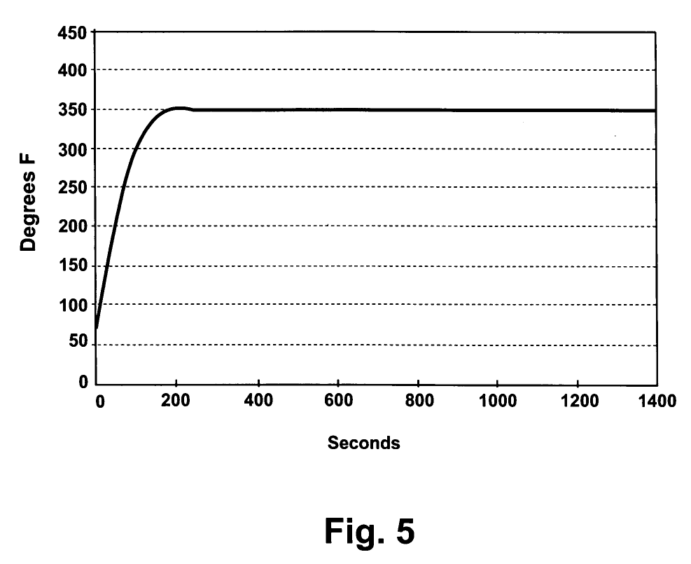

Referring to FIG. 5, a schematic illustration of a temperature profile of a gas oven according to the invention is given. The temperature profile plots the temperature of the cooking chamber 14 as a function of time, beginning with the initially heating of the oven from a “cold” state. As can be seen, once the cooking chamber temperature is raised to the temperature set point, there is little to no over- or under-heating of the cooking chamber 14, as evidenced by the relatively smooth temperature profile. Since the control system continuously adjusts the valve position based feedback from the temperature sensors 26, the temperature of the cooking chamber 14 remains at or very near the temperature set point.

While the invention has been specifically described in connection with certain specific embodiments thereof, it is to be understood that this is by way of illustration and not of limitation, and the scope of the appended claims should be construed as broadly as the prior art will permit.

What is claimed is:

1. A gas oven, comprising:
a housing defining a cooking chamber;
a temperature sensor outputting a temperature signal indicative of the air temperature of the cooking chamber;
a gas heating element heating the air in the cooking chamber;
a proportional valve regulating the supply of gas to the heating element in response to a control signal; and
a controller operably coupled to the temperature sensor to receive the temperature signal and operably coupled to the proportional valve, where the controller generates the control signal in response to the temperature signal to maintain the air temperature of the cooking chamber at a temperature set point.

2. The gas oven according to claim 1, further comprising a user interface operably connected to the controller and configured to permit a user to input a user-selected set temperature as the set point.

3. The gas oven according to claim 1, wherein the controller repeatedly receives the temperature signal and generates the corresponding control signal.

4. The gas oven according to claim 1, wherein the proportional valve comprises a motor to selectively open the valve in response to the control signal.

5. The gas oven according to claim 4, wherein the motor is infinitely adjustable to selectively move the proportional valve to one of an infinite number of positions between a closed position and a completely open position.

6. The gas oven according to claim 4, wherein the motor is discretely adjustable to selectively move the proportional valve to one of a discrete number of positions between a closed position and a completely open position.

7. The gas oven according to claim 6, wherein the motor is a stepper motor.

8. A method for maintaining the cooking temperature of a gas oven having a cooking chamber heated by a gas heating element at a set temperature, the method comprising:
sensing the air temperature of the cooking chamber; and
proportionally controlling the supply of gas to the gas heating element in response to the sensed air temperature to maintain the air temperature of the cooking chamber at the set temperature.

9. The method according to claim 8, and further comprising repeatedly sensing the air temperature of the cooking chamber and proportionally controlling the supply of gas in response to the repeatedly sensed air temperatures.

10. The method according to claim 9, wherein the repeated sensing of the air temperature and corresponding proportional controlling is conducted throughout an operational cycle

11. The method according to claim 10, wherein the supply of gas is proportionally controlled by moving a proportional valve.

12. The method according to claim 8, wherein the proportional control of the supply of gas is infinitely adjustable.

13. The method according to claim 8, wherein the proportional control of the supply of gas is discretely adjustable.

14. The method according to claim 13, wherein the discretely adjustable supply of gas is discretely adjustable in predetermined increments.

15. The method according to claim 14, wherein the predetermined increments are equal.

16. The method according to claim 14, wherein the predetermined increments are not equal.
